(19) United States
(12) Patent Application Publication
(10) Pub. No.: US 2014/0305510 A1
(43) Pub. Date: Oct. 16, 2014

(54) AUTOMATIC PASSIVE CONTROL OF LIQUID POSITIONING IN MICROFLUIDIC CHIPS

(71) Applicant: CONSIGLIO NAZIONALE DELLE RICERCHE, Roma (IT)

(72) Inventors: Vincenzo Piazza, Poggibonsi (IT); Giorgio De Simoni, Livorno (IT); Marco Cecchini, Calci (IT); Marco Travagliati, Cremona (IT); Fabio Beltram, Gorizia (IT)

(73) Assignee: CONSIGLIO NAZIONALE DELLE RICERCHE, Roma (IT)

(21) Appl. No.: 14/350,539

(22) PCT Filed: Oct. 10, 2012
(86) PCT No.: PCT/IB2012/055472

§ 371 Date: Apr. 8, 2014

(30) Foreign Application Priority Data
Oct. 10, 2011 (IT) TO2011A000900

(51) Int. Cl. F15C 1/04

(52) U.S. Cl. CPC F15C 1/04
USPC 137/13; 137/828

(57) ABSTRACT

A device for controlling liquid motion includes a substrate (10) of material having piezoelectric properties, and a system for controlling the motion of a quantity of liquid placed in contact with the substrate. The control system includes at least one interdigitated transducer (T1, T3, T5, T7), applied to the substrate (10) and designed for selectively generating a surface acoustic wave adapted to propagate on the substrate (10) and interact with the quantity of liquid. The control system further includes an acoustic resonator (30) which is placed on the path of the surface acoustic wave, and which is adapted to normally allow the forward transmission of the surface acoustic wave having a frequency equal to a resonance frequency of the acoustic resonator, and to reflect the surface acoustic wave back towards the transducer when the quantity of liquid is present within the acoustic resonator.

The present invention relates to a device for controlling liquid motion, comprising:
a support, and
control means for controlling the motion of a quantity of liquid placed in contact with said support, said control means including at least one surface acoustic wave generator applied to said support, which is designed for selectively generating a surface acoustic wave adapted to propagate on the support and interact with said quantity of liquid.

A device of this type is described, for example, in the publication WO 2009/013705 filed by the present applicant, and is particularly intended for the construction of what are known as “Lab-on-a-Chip” (hereinafter referred to as “LOC”) systems, in other words miniaturized diagnostic and analysis systems which are expected to form the next generation of apparatus for use in medical and other fields (for example, environmental monitoring or food analysis).

These systems are based on liquid handling; they must be capable of precisely supplying, moving and locating very small volumes of liquid (including those measured in picoliters). At present, location is carried out by active methods based mainly on the real time visualization of the liquid flow or on the measurement of specific electrical properties of the device. These methods are usually costly and difficult to integrate, and are based on active elements or electronic instruments.

Two classes of microfluidic devices can be distinguished, namely one using a continuous flow in microchannels, and one using droplets of small dimensions (digital microfluidics). In the latter class, three main methods of controllable movement have been developed, based on electrowetting (EW), thermocapillarity, and surface acoustic waves (SAW). EW and thermocapillary systems require the whole fluidic area (FA) to be provided with metallic electrodes or microheaters, which must be activated to move the droplets. Unlike these, the SAW technology is based on standing or travelling surface acoustic waves excited by microdevices integrated into the chip but positioned outside the FA. Other advantages of SAW fluidics include low-temperature and low-voltage operation, and an absence of constraints on the polarity of the liquid.

In a widely used SAW method, the surface acoustic waves are generated along the surface of a support (a substrate of piezoelectric material or a substrate provided with a film of piezoelectric material) by means of interdigitated metallic transducers (IDT). Interdigitated transducers are periodic structures composed of a succession of metallic strips (electrodes) interleaved in comb formation, connected alternately to collecting tracks for the distribution of the electrical signal. The geometry of the transducer and the properties of the support determine the resonance frequency for the excitation of the SAW. In the conventional configuration for the propagation of SAWs on a lithium niobate support, the resonance frequencies of a transducer are typically of the order of tens or hundreds of MHz. Different operating frequencies, or different periodicities of the transducer, can be used, depending on the typical dimensions of the micro- or nanofluidic network to which the transducer is coupled.

The acoustic wave is generated on the free surface of the piezoelectric support with elastic properties by applying an electrical signal to the metallic electrodes of the transducer. When an electrical signal of suitable frequency is applied between the transducer electrodes, the piezoelectric properties of the support cause the electrical signal to be converted into a deformation of the lattice of the support material, resulting in a periodic deformation of the free surface of the support under the transducer which can excite surface acoustic waves which propagate at the interface between the support and the air, or between the support and the layer above it.

SAWs are also used for transporting and moving small quantities (drops) of liquids deposited on free surfaces, in the direction of propagation of the acoustic wave.

In another method based on transduction for converting an electrical signal into acoustic vibrations, SAWs are generated on a non-piezoelectric material coupled to a piezoelectric material. In this case, a piezoelectric substrate is bonded to the side of a non-piezoelectric layer, and bulk acoustic waves (BAWs) are generated on the piezoelectric substrate, these waves being coupled to surface acoustic waves in the non-piezoelectric means [1].

Methods have also been developed for the optical generation of surface acoustic waves on non-piezoelectric substrates. In historical terms, the first method of photogeneration of surface acoustic waves was that of focusing an ultra-short laser pulse on the surface of the substrate. The energy of the pulse is absorbed by the substrate which is thus heated in the illuminated area, the heating extending to the depth of penetration of the laser light into the substrate. This heating causes a deformation of the crystal lattice of the substrate by thermal expansion, generating a packet of surface acoustic waves and longitudinal acoustic waves [2, 3]. At particularly high power levels, these conditions, known as thermoelastic conditions, give way to ablation conditions, in which ions and electrons from the surface of the substrate are brought to a plasma state and extracted from the surface, and the resulting moment pulse generates the acoustic waves in the substrate by compression [2, 3]. The method in the thermoelastic regime has subsequently been refined, with the use of transient gratings [4] and surface phononic crystals [5]. In the case of generation by transient grating, the laser pulse strikes the substrate in the form of a pattern with periodic strips, and the periodic heating of the substrate induces a periodic deformation of the substrate, thereby leading to the propagation of surface acoustic waves with wavelengths equal to the period of the illumination pattern [4, 5]. These patterns can be generated either by using diffraction gratings formed by periodic modulation of the thickness of a transparent substrate [4] or by creating interference between two laser beams [5]. In the method currently used to generate surface acoustic waves at higher frequencies, the substrate is patterned with a lattice of metallic micro/nanostructures (surface phononic crystal) [6]; when the laser pulse strikes the surface of the specimen, the energy of the pulse is absorbed by the nanostructures, which are heated and expand, thereby generating a periodic deformation of the substrate and also generating surface acoustic waves at that frequency. In order to excite specific surface modes, it is possible to use the transient grating method on a substrate nanopatterned with a surface phononic crystal [7].

Regardless of the method used for generating the SAWs, the development of programmable automated digital lab-on-a-chip systems requires the movement and location of the microdrops without the direct control of the operator. The inventors are aware of three different methods which have been described up to the present time for moving microdrops and detecting their positions on a SAW-based microfluidics platform.

The first method uses a plurality of SAW delay lines defining the fluidic area [8]. A parallel set of delay lines is used to move the drop, while a second set, perpendicular to the first, is used to locate the drop. The position of the drop is determined by measuring the transfer matrices of the delay lines: the presence of the drop leads to a variation of the transmission parameter (S₁₂ or S₂₁).

The second method uses two SAW delay lines based on wide-band “slanted” interdigitated transducers (IDTs) [9]. Here again, the operation is based on the measurement of the modification of the diffusion matrices of the delay lines caused by the presence of the liquid drop.

The third location method is based on SAW echoes [10, 11]: the movement and measurement of the position of the drop is carried out with the same IDT. In these chips, after the high-power radio-frequency pulse which moves the drop, a second low-power radio-frequency location pulse is applied. The measurement of the delay of the echo signal determines the position of the drop.

One object of the invention is to provide a microfluidic device based on surface acoustic waves which enables liquids to be located precisely without the use of any dedicated active microdevice or electronic instrument, and which therefore allows more integratable chips to be constructed.

In accordance with this object, the invention proposes a device of the type defined initially, in which said control means further comprise acoustic resonator means placed on the path of said surface acoustic wave, comprising a resonance cavity placed between a pair of acoustic reflectors arranged consecutively with respect to one another in the propagation direction of the surface acoustic wave, said acoustic resonator means being adapted to normally allow transmission of the surface acoustic wave having a frequency equal to a resonance frequency of said acoustic resonator means, and to reflect said surface acoustic wave when said quantity of liquid is present within said acoustic resonator means.

The method also proposes a method for controlling liquid motion, comprising the following steps:
providing a support,
placing a quantity of liquid in contact with said support, and
generating a surface acoustic wave adapted to propagate on the support and interact with said quantity of liquid;

wherein acoustic resonator means are placed on the path of said surface acoustic wave, said acoustic resonator means comprising a resonance cavity placed between a pair of acoustic reflectors which are arranged consecutively with respect to one another in the propagation direction of the surface acoustic wave, and which are adapted to normally allow transmission of the surface acoustic wave having a frequency equal to a resonance frequency of said acoustic resonator means, and to reflect said surface acoustic wave when said quantity of liquid is present within said acoustic resonator means.

By contrast with the solution proposed in references [10] and [11], the present invention does not require the use of pulsed radio-frequency signals or the switching of the transducer (IDT) from a pumping configuration to a detection configuration, which implies the stopping of the liquid motion.

By contrast with the method described in [9], the present invention can also operate at a single frequency (thus simplifying the circuitry) and can also operate with uniform IDTs, which are more efficient than “slanted” IDTs in the excitation of SAWs.

Furthermore, the invention does not require the development of a precise model for the spatial profile of the acoustic amplitude, which is necessary in [9] for determining the position of the microdrop. The present invention differs from the device described in reference [8] in that it does not require the fabrication of a plurality of transducers (IDTs), and the circuitry and construction of the device is thus simplified. The precision of location is also improved, because the device of reference [8] cannot detect drops which are positioned in regions between two different delay lines.

Finally, the device according to the invention is compatible with the use of standard polydimethylsiloxane (PDMS) microchannels.

Further characteristics and advantages of the device according to the invention will be made clear by the following detailed description, which refers to the attached drawings, provided purely by way of non-limiting example, in which:

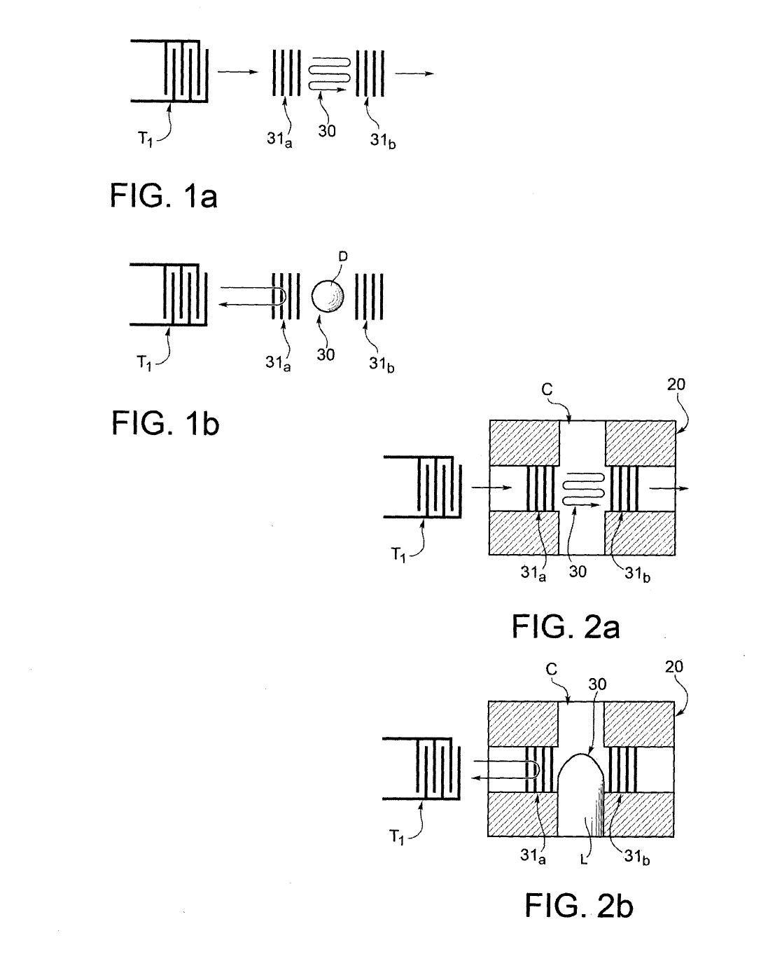

FIGS. 1 and 2 are schematic views illustrating the operating principle of the device according to the invention;

FIG. 3 is a schematic view of a prototype device with the geometrical details used for a numerical simulation;

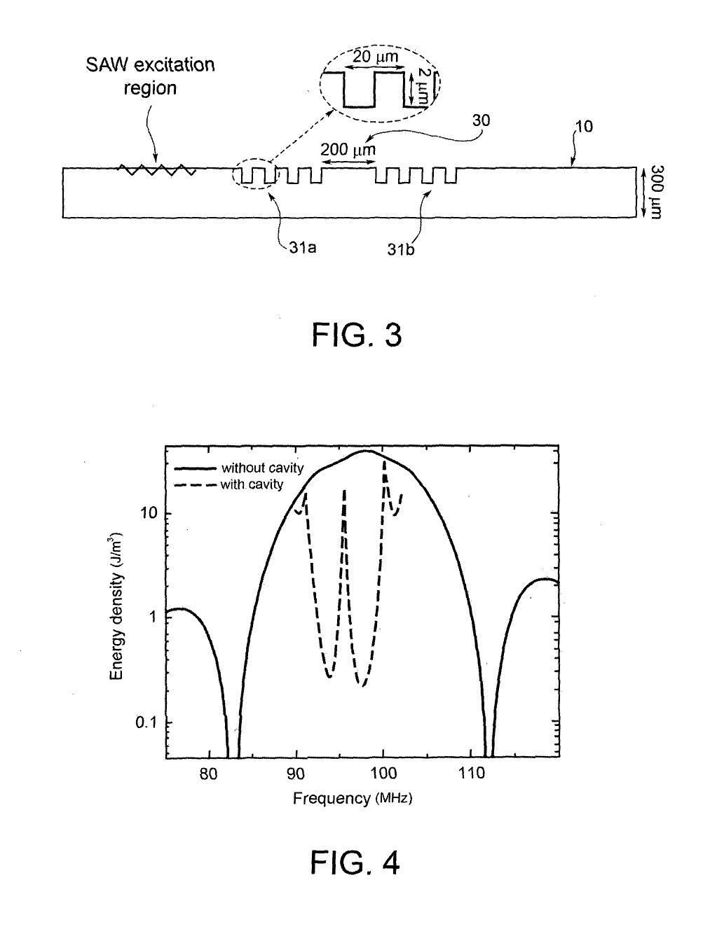

FIG. 4 is a graph showing the electromechanical energy density calculated at the end of a delay line of the device of FIG. 3, as a function of the frequency of the SAW excitation signal;

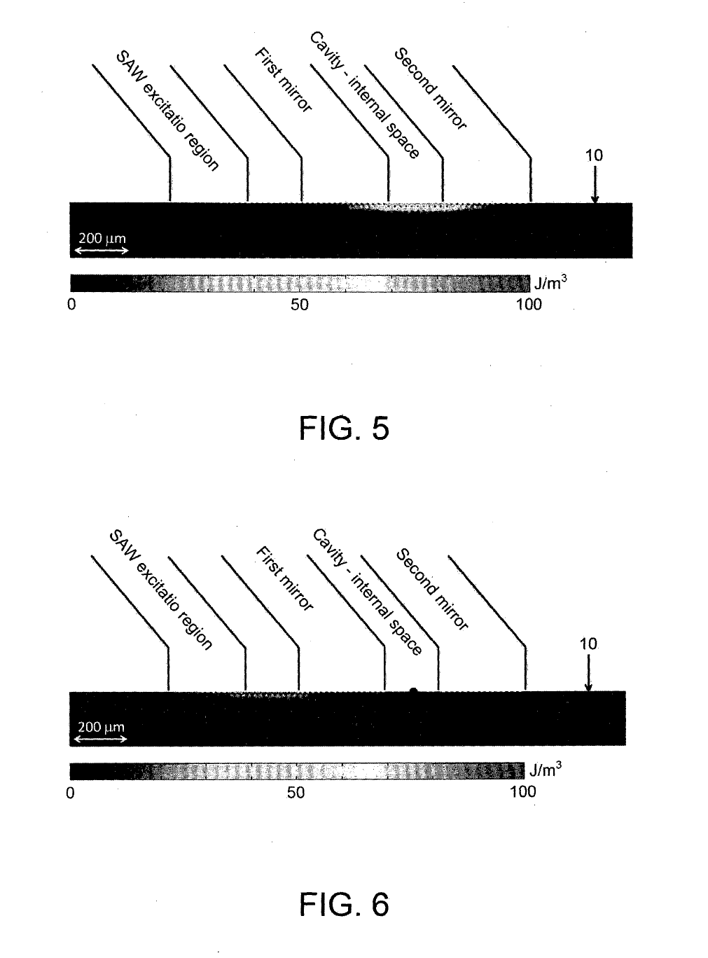

FIGS. 5 and 6 are graphs showing the two-dimensional distribution of the calculated electromechanical energy density in the device of FIG. 3, at the SAW excitation frequency, without and with absorbent material in the resonant cavity, respectively;

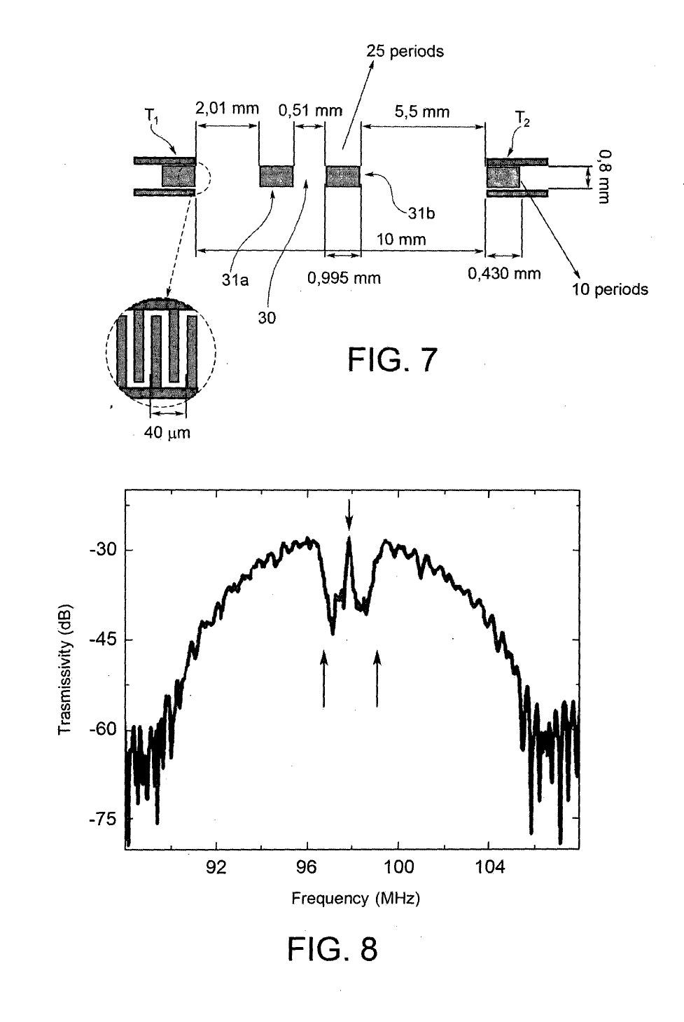

FIG. 7 is a schematic view of an experimentally constructed prototype device, with the corresponding geometrical data;

FIG. 8 is a graph showing the transmissivity of the delay line of the device of FIG. 7 as a function of the frequency of the SAW excitation signal;

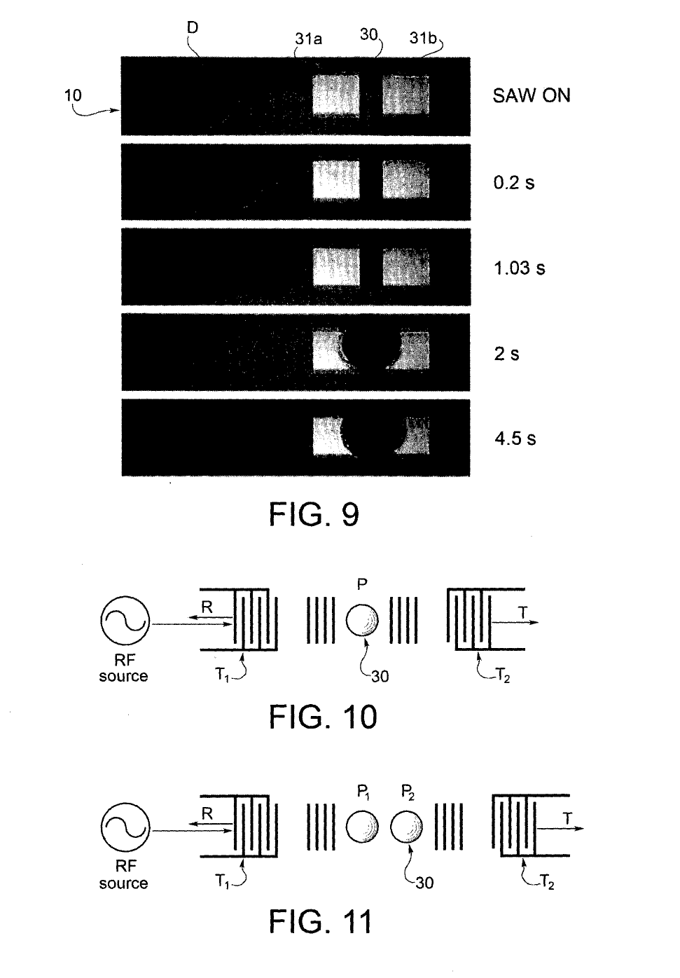

FIG. 9 shows a sequence of photographs depicting the temporal behaviour of a drop moving on the device of FIG. 7; and

FIGS. 10 to 14 show diagrams of examples of logic devices and systems for microdrop processing which can be constructed with the device according to the invention.

With reference to the drawings, a device for controlling liquid motion essentially comprises:
a substrate or support 10 (shown in FIG. 3, for example) made of material with piezoelectric properties, and
control means for controlling the motion of a quantity of liquid placed in contact with the support 10, said control means including one or more interdigitated transducers T₁-T₇ (shown in FIGS. 1, 2, 7 and 10-14) applied to said support 10, which are designed for selectively generating and/or detecting a surface acoustic wave adapted to propagate on the support 10 and interact with said quantity of liquid.

Although the present description refers exclusively to interdigitated transducers which, because of their simple construction, are highly suitable for the industrial production of fluidic chips, the invention is not limited to the specific procedures by which the surface acoustic waves are generated and detected. As an alternative to IDTs, it would be possible to use surface acoustic wave generators and detectors based on different methods, such as for example those described in the initial part of the present description.

Consequently, depending on the method used for generating and detecting surface acoustic waves, it would be possible to use a support comprising a non-piezoelectric substrate with a piezoelectric film, a support comprising a piezoelectric substrate coupled to a non-piezoelectric substrate, or a support containing no piezoelectric material, in place of the substrate (support) of piezoelectric material.

The aforementioned quantity of liquid may consist of one or more microdrops of liquid deposited on the surface of the support 10, or quantities of liquid travelling in micro- or nanochannels. In this second case, the device according to the invention further comprises a structured volume of material 20 (shown in FIGS. 2a and 2b) coupled to the support 10 and bearing a predetermined configuration of micro- or nanofluidic channels C (shown in FIGS. 2a and 2b) for containing and conveying quantities of liquid.

According to the invention, the means for controlling the liquid motion further comprise acoustic resonator means placed on the path of said surface acoustic wave, said acoustic resonator means being adapted to normally allow transmission of the surface acoustic wave having a frequency equal to a resonance frequency of said acoustic resonator means, and to reflect said surface acoustic wave when said quantity of liquid is present within said acoustic resonator means.

By way of example, the aforesaid acoustic resonator means comprise a resonance cavity 30 positioned between a pair of acoustic reflectors or mirrors 31a, 31b (shown, for example, in FIGS. 1 and 2) arranged consecutively with respect to one another in the direction of propagation of the surface acoustic wave. If a configuration of micro- or nanofluidic channels C is coupled to the support 10, the resonator means are positioned at a channel portion of the configuration of micro- or nanofluidic channels C.

The embodiments of FIGS. 1 and 2 are based on the properties of cavities composed of two highly reflective mirrors (Bragg mirrors), similar to the Fabry-Perot resonators used in optics, which are such that there are clear transmission lines at predetermined resonant frequencies. In the case of surface acoustic waves, the mirrors can be made with different methods and different geometries. For example, a simple approach is that of evaporating on to the support 10 a specified number of metallic strips arranged perpendicularly to the direction of propagation of the surface acoustic waves (also referred to hereinafter as SAWs), with a period equal to half the wavelength of the SAWs. In this case, the reflectivity of the mirror depends to a first approximation on the number of metallic strips of which it is made, the metal used, and its thickness. As an alternative to metallic strips, Bragg mirrors can be made by etching the substrate with a period equal to half the wavelength of the surface acoustic wave to be reflected.

As an alternative to the pair of Bragg mirrors separated by an area without patterning, other structures can be used to form the acoustic resonator means. Considerable interest has been shown recently in the use of phononic crystals [12, 13, 14] which consist of periodic systems of two or more materials with different elastic properties. It has been demonstrated that these structures, when suitably engineered, have a frequency region (band gap) in which no surface automodes of the system are permissible, and which therefore form spectral regions in which the system can act as a reflector, even in regions in which no Bragg reflections occur [15]. Suitable SAW transmission windows can be produced in these structures by using defects, not only by means of gap, in the periodic structure of the cavities and waveguides [14]. Phononic cavities can also be formed by constructed waveguides with closed geometries, as in the case of ring resonators [16, 17].

Except as regards the specific structure of the resonator means, the operating principle of the present invention is essentially the same.

In resonance conditions, SAWs are completely transmitted through the cavity. If an absorbent material is present in the cavity, it acts as a virtually perfectly reflecting mirror, thus back reflecting the SAWs. It is important to note at this point that the reflection takes place with minimal energy losses in the SAWs; for example, in the case of cavities based on two semi-reflecting mirrors, if a perfect absorber is present in the resonance cavity the losses are proportional to the transmissivity of the entrance mirror, which can theoretically be made arbitrarily low.

Since liquids are highly efficient absorbers of SAWs, this arrangement enables the SAWs to be routed to different areas of a chip, and therefore to different specimens of liquid which may be present in the chip, depending on whether or not liquid is present in the resonance cavities.

FIGS. 1 and 2 show schematically the operating principle of the invention in the case of a digital microfluidic chip (FIGS. 1a and 1b) and in the case of a chip based on microchannels (FIGS. 2a and 2b). The grey arrows in FIGS. 1 and 2 show schematically the path of the SAWs. At the resonance frequency of the cavity 30, the SAW generated by the transducer T₁ is completely transmitted forwards (FIGS. 1a and 2a). When a drop D or a quantity of liquid L which fills a channel reaches the resonance cavity, the SAW generated by the interdigitated transducer T₁ is reflected back towards the same transducer T₁ (FIGS. 1b and 2b). The electrical radio-frequency signal generated by the reflection of the SAW in T₁ can thus be routed to a different interdigitated transducer by means of an on-chip or off-chip directional coupler, for the purpose of guiding the liquid in a different direction or handling a different specimen of liquid. Examples of possible architectures are described below.

In order to demonstrate the operating principle of the present invention, numerical simulations and experimental tests were conducted.

A prototype device was modelled by means of a two-dimensional finite element method capable of simulating SAWs propagated along the direction X of a plate of LiNbO₃ with a size of 128Y-X, which is the preferred material at present for SAW-based microfluidics. On the path of the SAW, a Fabry-Perot acoustic cavity was constructed with a pair of distributed mirrors, each consisting of 15 pairs of vacant/solid strips (more precisely, there were 15 pairs of strips spaced apart by a distance equal to the wavelength λ_{SAW} of the surface acoustic wave, in other words a structure having 30 strips with a period of λ_{SAW}/2). The excitation of the SAWs was modelled by applying an alternating voltage with the correct spatial periodicity to the surface of the plate. The geometrical details of the simulation are shown in FIG. 3.

FIG. 4 shows the spectra calculated for the delay line with the cavity (broken line) and without the cavity (continuous line). This graph was produced by plotting the electromechanical energy density at the end of the delay line (see also FIG. 5) as a function of the frequency of the SAW excitation signal.

FIG. 5 shows the two-dimensional distribution in the plate of the electromechanical energy density calculated at the SAW excitation frequency, equal to f₂.

As can be seen, with the chosen material and geometry the cavity supports three surface acoustic modes, and, at the resonance frequency (f₁=91.14 MHz, f₂=95.52 MHz, f₃=100.26 MHz), the electromechanical energy density is mainly confined to the spatial region located between the mirrors and within a wavelength from the surface of the plate.

Additionally, for the central peak of the cavity (f₂), the transmittance of the cavity, calculated as the ratio between the power leaving the second mirror (on the right in FIG. 5) and the power leaving the SAW excitation region, is equal to 0.48.

The situation in which an absorbent material is present in the cavity was modelled by including a hemisphere with the electromechanical properties of water between the mirrors. FIG. 6 shows the two-dimensional distribution in the plate of the electromechanical energy density calculated at the SAW excitation frequency, equal to f₂, with the absorbent material in the internal space of the cavity. It should be noted that, even if its description of the SAW-liquid interaction is not accurate, the above approach is sufficient for the purposes of the present analysis, since the results of the simulation are not dependent on the details of the absorption mechanism. In this situation, the cavity acts as a quasi-perfect mirror and, in resonance conditions, the electromechanical energy density is mainly confined between the SAW excitation region and the first mirror (on the left in FIG. 6). It should be noted that, since the electromechanical energy density is virtually zero inside the cavity, the SAW-liquid interaction is negligible for practical purposes.

Different prototypes were then constructed on a LiNbO₃ support of the 128Y-X size. Aluminium interdigitated transducers (with a period of 40 μm, a duty cycle of 50%, and 10 periods) were deposited on the support to form SAW delay lines. An acoustic cavity was fabricated within each delay line in the same stage of processing. The cavities consist of a pair of mirrors, each formed by a series of strips of Al (period 20 μm, duty cycle 50%, 25 periods). The geometrical details of one of the prototype devices, comprising an interdigitated transducer T₁ for generating the SAWs and an interdigitated transducer T₂ for detecting the power transmitted through the delay line and the cavity, are shown in FIG. 7.

The characteristic curve of transmittance of the delay line of FIG. 7 is shown in FIG. 8 as a function of the frequency of the SAW excitation signal; as can be seen, there is a resonance mode of the cavity at high transmissivity. The frequency range between the upward pointing arrows in FIG. 8 corresponds to the rejection band of the mirror. This is demonstrated by the presence of the two transmittance minima corresponding to a partially reflected SAW. Between the two minima there is a transmittance peak (indicated by the downward pointing arrow), corresponding to the resonance frequency of the cavity. At this frequency (fᵣₑₛ=97.85 MHz) in the cavity, a resonant mode appears in which there is high transmissivity through the cavity. For the purposes of SAW fluidics, the device is made to operate at the resonance frequency of the cavity.

The prototype device can position a drop of water within the cavity space. The operating procedure is as follows:
a drop of water is deposited between the generating interdigitated transducer and the first mirror of the cavity;
the aforesaid transducer is activated at the resonance frequency.

FIG. 8 is a time sequence of photographs showing the behaviour of the drop on a prototype of the device according to the invention, under the action of a SAW propagating from the left to the right in the photographs.

It was observed that:
the drop was pushed by the SAW past the first mirror into the cavity;
the drop remained stationary in the cavity without any further significant movement and without any evaporation due to a transfer of power from the SAW.

When the experiment was repeated at frequencies outside the operating range of the mirror, the drop was pushed beyond the cavity, because the cavity was ineffective outside the resonance range.

The present invention therefore proposes a device which can be fabricated on microfluidic chips, for guiding surface acoustic waves passively and with minimal losses, depending on the position of the liquids on the chip. The device which has been described can therefore function in a similar way to a logic gate of an electronic microchip, making it possible to guide a plurality of fluids, such as drops deposited on a surface of the device or liquids present in microfluidic channels, into specific positions, without the need for external control or feedback. The same complex microfluidics task can thus be carried out in a repetitive way without the need for external supervision.

In this context, some possible examples of basic logic units and applications which can be produced by means of the present invention will now be described for illustrative purposes with reference to FIGS. 10 to 14.

The example in FIG. 10 represents a NOT/identity gate. If P indicates the presence (P=1) or absence (P=0) of a drop in the cavity, the transmitted signal T is approximately equal to “NOT P”, while R≈P, where R is the reflected signal. The reflected signal and the transmitted signal can be routed to other transducers for further processing. The truth table is as follows:

| T | R | P |
|---|---|---|
| 1 | 0 | 0 |
| 0 | 1 | 1 |

The example in FIG. 11 represents a NOR/OR gate. If P₁ and P₂ indicate the presence (Pᵢ=1) or absence (Pᵢ=0) of two drops in the cavity, the transmitted signal T is approximately equal to “P₁ NOR P₂”, and R≈P₁ OR P₂. The truth table is as follows:

| T | R | P₁ | P₂ |
|---|---|---|---|
| 1 | 0 | 0 | 0 |
| 0 | 1 | 1 | 0 |
| 0 | 1 | 0 | 1 |
| 0 | 1 | 1 | 1 |

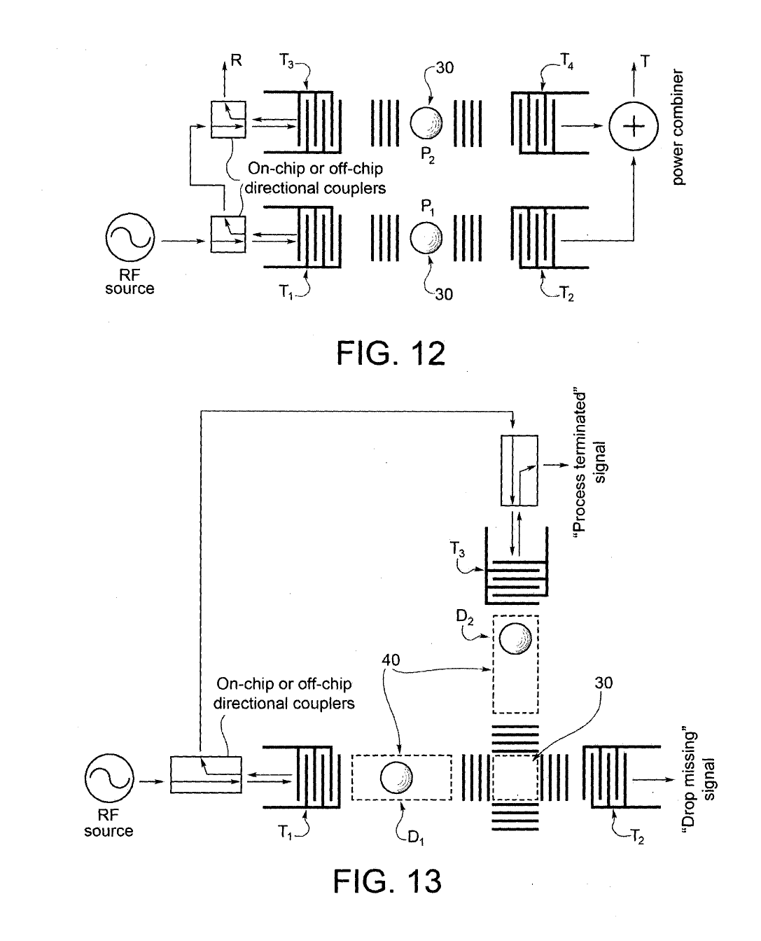

The example in FIG. 12 represents a NAND/AND gate. If P₁ and P₂ indicate the presence (Pᵢ=1) or absence (Pᵢ=0) of two drops in the two cavities, the transmitted signal T is approximately equal to “P₁ NAND P₂”, and R≈P₁ AND P₂. The arrows in FIG. 12 represent the flow of the electrical radio-frequency signal. This signal is routed by two directional couplers, which can be fabricated on-chip or off-chip. The truth table is as follows:

| T | R | P₁ | P₂ |
|---|---|---|---|
| 1 | 0 | 0 | 0 |
| 1 | 0 | 1 | 0 |
| 1 | 0 | 0 | 1 |
| 0 | 1 | 1 | 1 |

The example in FIG. 13 represents an application for the automatic sequential positioning of two drops D₁ and D₂ in the centre of the chip, for example in a reaction area where the drops can react. This reaction area coincides with an acoustic cavity 30 delimited by two pairs of mirrors in corresponding perpendicular directions. The number 40 indicates the areas of deposition of the drops. The arrows in FIG. 13 represent the flow of the electrical radio-frequency signal. This signal is routed by two directional couplers, which can be fabricated on-chip or off-chip.

The drops are positioned automatically after the user has deposited the two drops in the deposition area 40 and activated the radio-frequency source. A “process terminated” signal is generated by the transducer T₃ when both drops have reached the chemical reaction region. If the drop D₁ is missing, an error signal is generated by the transducer T₂.

The operating sequence of the system shown in FIG. 13 is as follows:
the user positions two drops of reagent, D₁ and D₂, in the deposition regions 40.

The positioning of the drops in the aforesaid regions does not have to be accurate;
a radio-frequency signal is applied;
if the drop D₁ is not present, the SAWs generated by, the transducer T₁ pass through the cavity 30 and reach the transducer T₂, where they are converted into an electrical signal which warns that the drop D₁ is missing. There is no further action;
if the drop D₁ is present, it is pushed by the SAWs into the cavity 30. When the drop enters this cavity, the first mirror of the horizontal cavity reflects the SAWs back towards the transducer T₁, where they are converted back to an electrical signal which is routed, by means of the directional coupler, to the transducer T₃;
the SAWs generated by the transducer T₃ push the drop D₂ into the cavity 30, where it encounters the drop D₁ and the reaction can take place. Since the vertical cavity is in an “absorbent” state, the SAWs arriving from T₃ are re-routed towards this transducer;
finally, the SAWs which reach T3 are converted back into a radio-frequency signal, which is routed by another directional coupler to another part of the fluidic chip to move other drops, or is used as a “process terminated” signal.

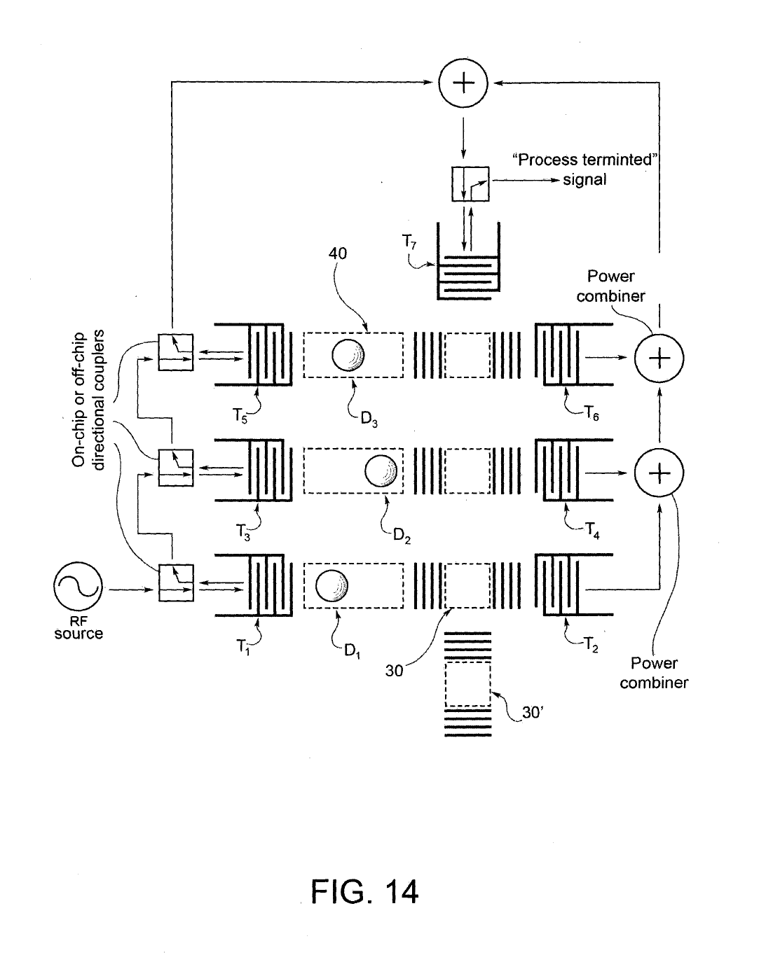

The example in FIG. 14 represents an application for the automatic sequential positioning of a plurality of drops in reaction areas and the extraction of the resulting solution. When all the drops D1, D2, D3 have been positioned in the reaction areas, they are brought into contact (D2 with D3 initially, and then the resulting drop with D1). Finally, the result is pushed towards an output region 30′ (also formed by an acoustic cavity) for further processing, and a “process terminated” signal is generated by the transducer T₇.

The operating sequence of the system is as follows:
the user positions three drops of reagent, D₁, D₂ and D₃, in the deposition regions 40. The positioning of the drops in these regions does not have to be accurate;
a radio-frequency signal is applied;
the SAWs generated by the transducer T₁ push the drop D₁ into the chemical reaction region (acoustic cavity) 30 in the lowest position in the figure. When the drop enters, the first mirror of the horizontal cavity reflects the SAWs back towards the transducer T₁, where they are converted back to an electrical signal which is routed, by means of a directional coupler, to the transducer T₃;
the SAWs generated by the transducer T₃ push the drop D₂ into the chemical reaction region (acoustic cavity) 30 in the middle position in the figure. When the drop enters, the first mirror of the horizontal cavity reflects the SAWs back towards the transducer T₃, where they are converted back to an electrical signal which is routed, by means of a directional coupler, to the transducer T₅;
the SAWs generated by the transducer T₅ push the drop D₃ into the chemical reaction region (acoustic cavity) in the uppermost position in the figure. When the drop enters, the first mirror of the horizontal cavity reflects the SAWs back towards the transducer T₅, where they are converted back to an electrical signal which is routed, by means of a directional coupler, to the transducer T₇;
at this point, the three drops are aligned in the three reaction regions. The SAWs from the transducer T₇ push the drop D₃ towards the drop D₂;
when the uppermost cavity 30 is vacated, the SAWs generated by the transducer T₅ propagate through the cavity and reach the transducer T₇ via the transducer T₆ and the upper power combiner (which can also be either on-chip or off-chip). The result of the reaction D₂-D₃ is therefore pushed towards the drop D₁;
as in the preceding case, when the uppermost cavity 30 is vacated, the transducer T₇ is again excited via the transducer T₄ and the lower power combiner;
the end result is pushed by the SAWs generated by the transducer T₇ out of the lowest cavity 30;
when the lowest cavity 30 is vacated, the transducer T₇ is again excited via the transducer T₂, and pushes the resulting drop into the output region 30′;
the SAWs are reflected from the vertical cavity 30′ around the output region back towards the transducer T7 where a “process terminated” signal is generated through a directional coupler.

In complex systems, the insertion and coupling losses can be compensated for by radio-frequency amplifiers positioned, for example, at the outputs of the directional couplers.

Although the examples described above relate to applications in which the fluidic device operates at a single frequency, it is possible to design devices according to the invention which also operate at a plurality of frequencies (with resonators having different resonance frequencies); using a plurality of operating frequencies, it is possible to increase the complexity of the fluidic task to be carried out, for example, drops can be moved from one resonator to another on the same delay line, or a drop can be halted and then put into motion again.

### REFERENCES

[1] Rouvaen et al., J. Phys. D: Appl. Phys 35, 378 (2002)
[2] Royer and Dieulesaint, Elastic Wave in Solids, Springer (2000)
[3] Davies et al., J. Phys. D: Appl. Phys. 26, 329 (1993)
[4] Antonelli et al., Physica B 316-317, 277 (2002)
[5] Crimmis et al., Appl. Phys. Lett. 74, 1344 (1999)
[6] Siemens et al., Appl. Phys. Lett. 94, 093103 (2009)
[7] Maznev and Wright, J. Appl. Phys. 105, 123530 (2009)
[8] S. Alzuaga et al., IEEE Ultrason. Symp. 2, 1790 (2003)
[9] T.-T. Wu and I.-H. Chang, J. Appl. Phys. 98, 024903 (2005)
[10] A. Renaudin et al., J. Appl. Phys. 100, 116101 (2006)
[11] A. Renaudin et al., Sens. Actuators 138, 374 (2009)
[12] Siemens et al., Appl. Phys. Lett. 94, 093103 (2009)
[13] Maznev and Wright, J. Appl. Phys. 105, 123530 (2009)
[14] Olsson and El-Kady, Meas. Sci. Technol. 20, 012002 (2009); Pennec et al., Surf. Sci. Rep. 65, 229 (2010)
[15] Achaoui et al., Phys. Rev. B 83, 104201 (2011)
[16] Maznev, Ultrasonics 49, 1 (2009)
[17] Biryukov et al., J. Appl. Phys. 106, 126103 (2009)

1. Device for controlling liquid motion, comprising:
a support, and
control means for controlling the motion of a quantity of liquid placed in contact with said support, said control means including at least one surface acoustic wave generator, which is designed for selectively generating a surface acoustic wave adapted to propagate on the support and interact with said quantity of liquid;
wherein
said control means further comprise an acoustic resonator placed on the path of said surface acoustic wave, and comprising a resonance cavity placed between a pair of acoustic reflectors arranged consecutively with respect to one another in the propagation direction of the surface acoustic wave, said acoustic resonator being adapted to normally allow transmission of the surface acoustic wave having a frequency equal to a resonance frequency of said acoustic resonator, and to reflect said surface acoustic wave when said quantity of liquid is present within said acoustic resonator.

2. Device according to claim 1, wherein said support comprises a substrate made of material with piezoelectric properties or has a film of material with piezoelectric properties, and wherein said at least one surface acoustic wave generator is formed by a corresponding interdigitated transducer applied to said support.

3. Device according to claim 1, further comprising a structured volume of material coupled to said support and bearing a predetermined configuration of microfluidic channels or nanofluidic channels for containing and conveying quantities of liquid, wherein said acoustic resonator is positioned at a channel portion of said configuration of microfluidic channels or nanofluidic channels.

4. Method for controlling liquid motion, comprising the following steps:
providing a support,
placing a quantity of liquid in contact with said support, and
generating a surface acoustic wave adapted to propagate on the support and interact with said quantity of liquid;
placing an acoustic resonator on a path of said surface acoustic wave, said acoustic resonator comprising a resonance cavity placed between a pair of acoustic reflectors which are arranged consecutively with respect to one another in a propagation direction of the surface acoustic wave, and which are adapted to normally allow transmission of the surface acoustic wave having a frequency equal to a resonance frequency of said acoustic resonator, and to reflect said surface acoustic wave when said quantity of liquid is present within said acoustic resonator.

5. Method according to claim 4, wherein
said quantity of liquid is initially placed on the path of said surface acoustic wave, upstream of said acoustic resonator with respect to the propagation direction of said surface acoustic wave being transmitted forwards;
said surface acoustic wave is generated in such a way as to cause said quantity of liquid to move forwards towards said acoustic resonator; and
when said quantity of liquid reaches said acoustic resonator, further forward motion of said quantity of liquid is stopped due to the back reflection of the surface acoustic wave by said acoustic resonator.
